(19) United States
(12) Patent Application Publication
(10) Pub. No.: US 2005/0150364 A1
(43) Pub. Date: Jul. 14, 2005

(54) Multi-mode multi-coil pickup and pickup system for stringed musical instruments

(75) Inventors: Edwin Krozack, Chester, MD (US); Paul Reed Smith, Lothian, MD (US); John Ingram, Annapolis, MD (US)

Correspondence Address: BARNES & THORNBURG, 750-17TH STREET NW, SUITE 900, WASHINGTON, DC, 20006, US

(73) Assignee: Paul Reed Smith Guitars, Limited Partnership

(21) Appl. No.: 10/754,689

(22) Filed: Jan. 12, 2004

(51) Int. Cl. G10H 3/18

(52) U.S. Cl. 84/726

(57) ABSTRACT

A stringed musical instrument having a pickup system including at least one dual coil pickup, each coil having first and second end terminals and at least one tap to a portion of the coil between the first and second end terminals. A first or mode switch selectively connects first and second output terminals of a pickup circuit to (a) the first end terminals of both coils, (b) the first and a second end terminals of one of the coils, and (c) the at least one tap of both coils. Selection (c) allows for a selection of less than two full coils. The musical instrument includes additional pickups and a second or pickup selector switch to selectively connect the pickups and the first switch to the first output terminal of the pickup circuit.

### BACKGROUND AND SUMMARY OF THE DISCLOSURE

The present disclosure is directed to an electromagnetic pickup system for stringed musical instruments and, more specifically, to an improved pickup and pickup system for stringed musical instruments.

The electrification of stringed musical instruments includes pickups to pick up the vibration of the strings and convert them into electrical signals. There are two main classes of pickups. One is electromagnetic pickups, which sense vibration of the string in a magnetic field. The other class is piezoelectric pickups, which contact the string and senses its movement. Many kinds of electromagnetic pickups have been designed for stringed instruments. These include single coils and dual hum canceling coils. The dual hum canceling coil is designed and wired to cancel the electric noises and interference picked up by the coils. The two coils have opposite magnetic and electrical polarities. The noise, which is electrically induced in the coils, cancel each other out.

The number of double and single coils along the strings of a musical instrument has varied in the industry. One example is two dual hum canceling coil pickups spaced along the strings with a single coil pickup in between. Various switching arrangements have interconnected the various coils. Switching has included connecting only one coil of the hum canceling pair of coils to the output circuitry. This is usually achieved by connecting the center tap between the two hum canceling coils to ground or to hot. Various impedances have also been connected with the coils to change their frequency response.

The present disclosure is directed a stringed musical instrument having a pickup system including at least one dual coil pickup, each coil having first and second end terminals and at least one tap to a portion of the coil between the first and second end terminals. A first or mode switch selectively connects first and second output terminals of a pickup circuit to (a) the first end terminals of both coils, (b) the first and second end terminals of one of the coils, and (c) the at least one tap of both coils. Selection (c) allows for less than a full coil of both coils. The tap is generally to a portion of between 55 and 80 percent of the winding between the first and second terminals. The second terminals of the first and second coils may be connected to each other for hum canceling.

The disclosed stringed musical instrument pickup system may alternatively include two dual coil pickups, each coil having first and second end terminals and at least one tap to a portion of the coil between the first and second end terminals. A first or mode switch selectively connects first and second output terminals of a pickup circuit to (a) the first end terminals of both coils of both pickups and (b) the taps of both coils of both pickups. In this embodiment, the mode switch changes both pickups simultaneously.

The musical instrument includes additional pickups and a second or pickup selector switch to selectively connect the pickups and the first switch to the first output terminal of the pickup circuit. The second output terminal of the pickup circuit is connected to ground. One of the additional pickups is a dual pickup having the first and second terminals and the tap. Another additional pickup may be a single pickup having first and second terminals.

The disclosure is also directed to dual coil pickup for a stringed instrument, the pickup having first and second coils having first and second end terminals. Each coil has at least one tap to a portion of the coil between the first and second end terminal. The second end terminals connect the two coils in a hum canceling arrangement between the first terminals and between the taps.

These and other aspects of the present disclosure will become apparent from the following detailed description of the disclosure, when considered in conjunction with accompanying drawings.

### BRIEF DESCRIPTION OF DRAWINGS

FIG. 1 is a plane view of a stringed musical instrument incorporating the pickups of the present disclosure.

FIG. 2 shows the details of the terminals and taps of the pickups of FIG. 1 incorporating the principles of the present disclosure.

FIG. 3 shows a switching arrangement for the pickup system of FIG. 1.

FIG. 4 shows another switching arrangement for the pickup system of FIG. 1.

### DETAILED DESCRIPTION OF THE PREFERRED EMBODIMENTS

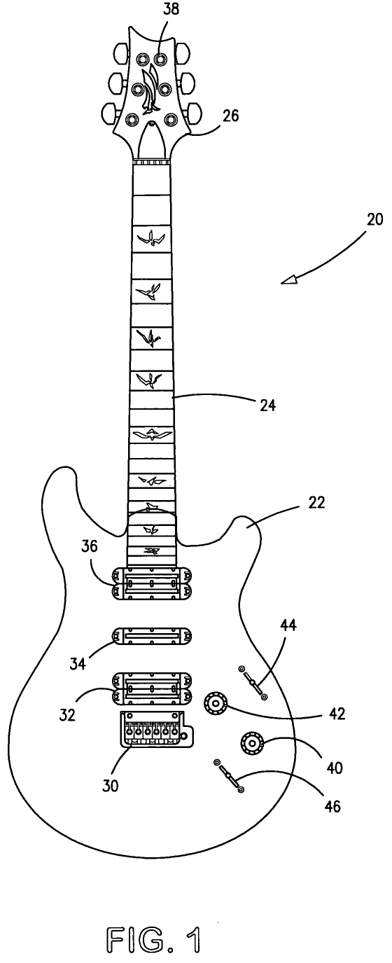

FIG. 1 shows a musical instrument 20 having a body 22, neck 24 and headstock 26. Strings (not shown for sake of clarity) extend from the bridge 30 over pickups (for example, 32, 34 and 36) and over the neck 24 to tuning machines 38 at the headstock 26. Although the musical instrument 20 is shown as a 6-stringed guitar, it may be a 12-string guitar, a 5-string bass or any other electric stringed musical instrument. The type of instrument and the number of strings are merely examples. Pickups 32, 36 are dual coil hum canceling pickups, while pickup 34 is a single coil pickup. Less than three pickups (or five coils) may be used. The present disclosure is directed to a unique structure for the dual hum canceling pickups 32, 36 and the selective switching.

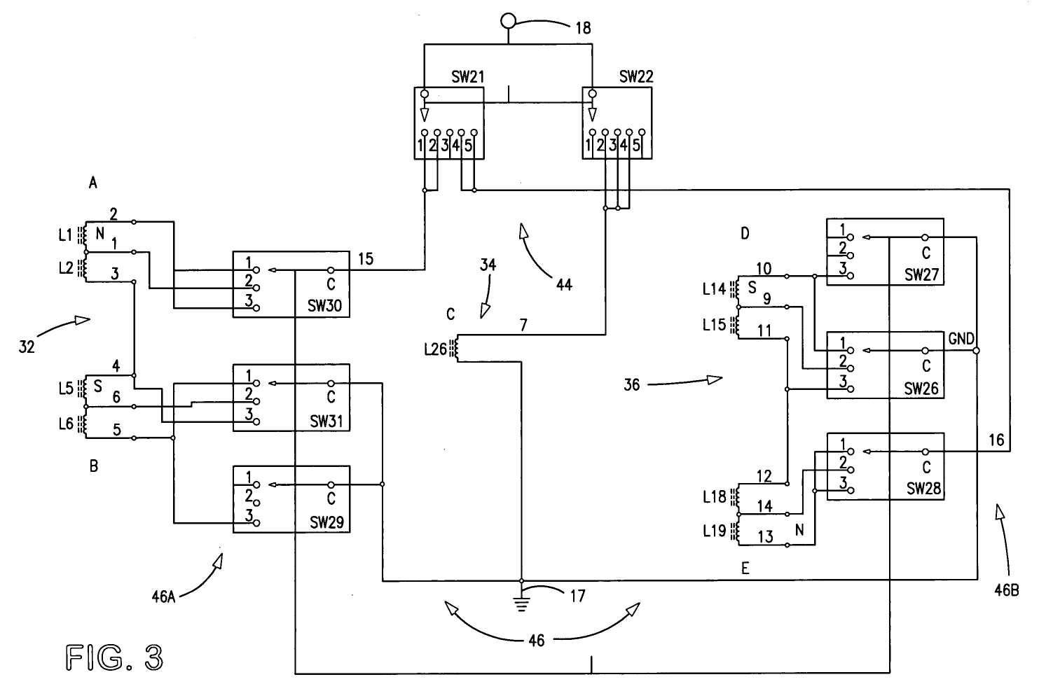

The pickups 32, 34, 36 are connected to circuitry within the musical instrument 20. Knob 40 is a tone knob, and knob 42 is a volume control knob. Knobs 40, 42 are shown as rotary potentiometers but also may be slide potentiometers. Switch 44 is a pickup selection switch to select interconnection of the pickups 32, 34, 36. Switch 46 is a mode selection switch to select between at least two hum canceling modes and single mode or configuration of the dual hum canceling coils 32, 36. Switches 44, 46 are shown as blade-type rotary switches, although they may be other types of switches, including digital switches. As will be explained in more detail with respect to FIG. 3, switch 46 is a three-position, six-pole switch, while switch 44 is a five-position, two-pole switch. These are examples of the types of switches that can be used.

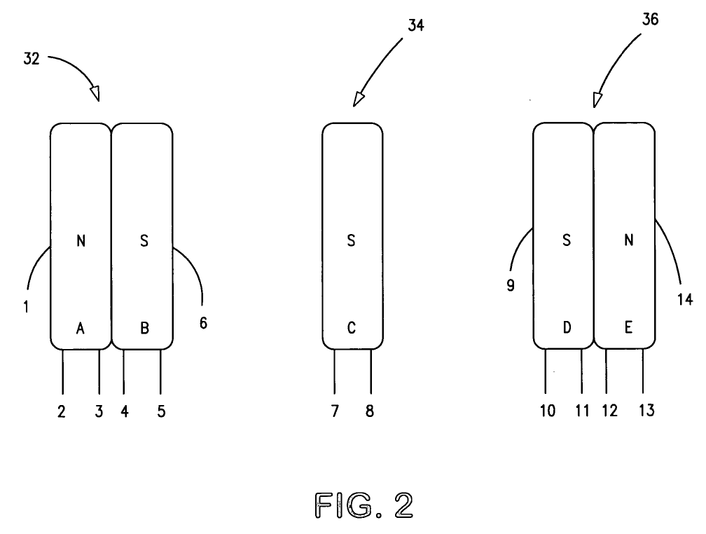

The dual hum canceling coils 32, 36 are illustrated in FIG. 2. The dual coil 32 includes coils A and B, with coil A being of one magnetic polarity (shown as north), and coil B being of opposite magnetic polarity (shown as south). Terminals 2 and 3 are the end terminals of coil A, and terminals 4 and 5 are the end terminals of coil B. Coil A also has a tap 1 connected to a portion of the coil between the first and second terminals 2 and 3. Similarly, coil B includes end terminals 4 and 5 and a tap 6 connected to a portion of coil B between the first and second terminals 4 and 5. The second ends 3 and 4 of coils A and B are shown disconnected but are generally connected either in the pickup 32 or in the switching arrangement.

For a full hum canceling effect (more amplitude and lower resonant frequency), the electronics are connected between terminals 2 and 5 of pickup 32. For less than a full hum canceling effect (less amplitude and higher resonant frequency), the output terminals are connected between taps 1 and 6 of pickup 32. For a single coil effect, the output terminals are connected to terminals 2 and 3 or 4 and 5. Single coil 34 has end terminals 7 and 8, with terminal 8 being connected to ground.

Dual hum canceling pickup 36 also has two coils D and E, each with two terminals and a tap. Terminals 10 and 11 are the first and second end terminals of coil D, with 9 being the tap to a portion of the coil between the first and second terminals 10 and 11. Coil E has first and second end terminals 12, 13 and a tap 14 to a portion of the coil between the first and second terminals 12, 13.

The taps 1, 6, 9 and 14 may be to a portion between 55 and 80 percent of the windings between the first and second terminals. Also more than one tap may be provided between the end terminals. The full and less than full hum canceling is a matter of personal taste and may vary.

A switching arrangement to allow full hum canceling or less than full hum canceling, as well as selection of single coil of the dual coil pickup(s), is illustrated in FIG. 3. Switch 46 is illustrated as a three-position, six-pole switch. Each of the poles are ganged together. In the fill hum canceling arrangement (position 1), terminals 2 and 5 of pickup 32 and terminals 10 and 13 of pickup 36 are selected. In the example shown, terminals 5 and 10 are connected to ground at output terminal 17, and terminals 2 and 13 are connected to output terminals 15 and 16, respectively. For less than full hum canceling (position 2), taps 1 and 6 of pickup 32 and taps 9 and 14 of pickup 36 are selected. Taps 6 and 9 are connected to ground at output terminal 17, and taps 1 and 14 are connected to output terminals 15 and 16, respectively. In the single coil selection (position 3) of the hum canceling pickups, terminals 2 and 3 are selected for coil A of pickup 32, and terminals 12 and 13 of coil D of pickup 36 are selected. Terminals 3, 4 and 5 of coils A and B and terminals 10, 11 and 12 of coils D and E of pickups 32, 36 are selectively connected to ground. Terminals 2 and 13 of coils A and E are connected to output terminals 15 and 16, respectively.

Output terminals 15 and 16 are selectively connected to switch 44. Switch 44 is shown as a two-pole, five-position switch of the prior art. Other pickup selection switches may be used. In the first position of switch 44, pickup 32 alone is selected. Depending upon the position mode switch 46, it will either be full hum canceling, less than full hum canceling or a single coil of pickup 32. In the second position, pickup 32 and single coil pickup 34 are selected. In the third or center position, only the single coil pickup 34 is selected. In the fourth position, single coil pickup 34 and pickup 36 are selected. In the fifth position, only pickup 36 is selected. Thus, while mode switch 46 selects the configuration of the pickups 32, 36, selection switch 44 selects the interconnection of the pickups 32, 34, 36. The position of the switch 44 connects switch 46 to the hot or plus output terminal 18. Output terminals 17 and 18 represent the output terminals of the pickup circuitry, which are connected to electronics in the musical instrument or exterior to the musical instrument.

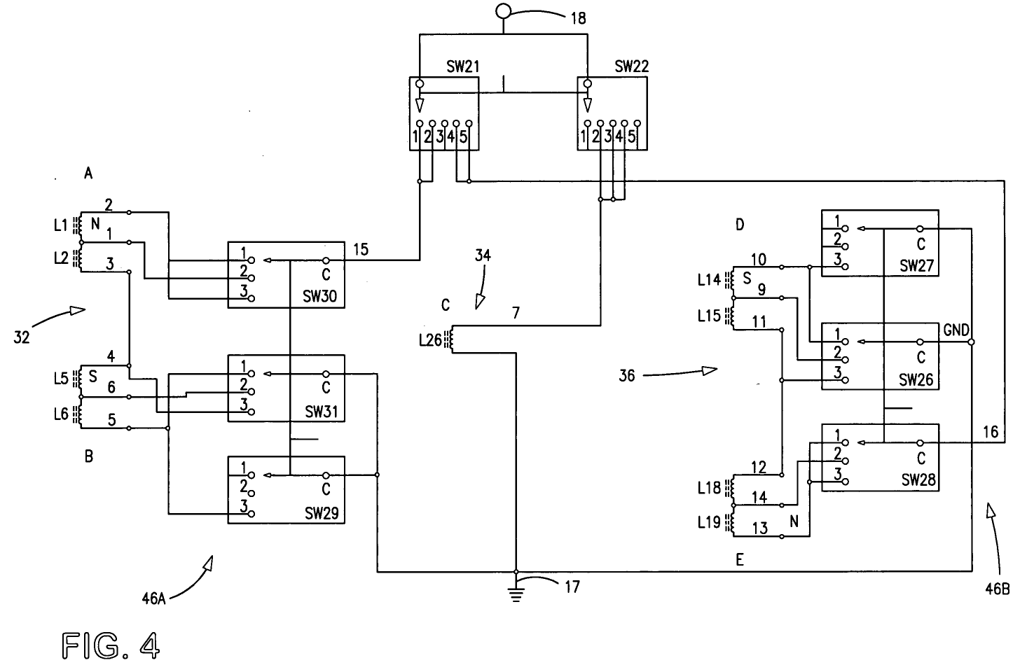

While FIG. 3 shows a single mode switch 46 for simultaneously selecting the mode of both dual coil pickups 32 and 36, FIG. 4 shows a mode switch 46A and 46B for each of the dual coil pickups 32 and 36. Each mode switch 46A, 46B is a three-pole, three-position switch.

Although the dual hum canceling pickups 32, 36 are shown as horizontally adjacent pickups on a common carrier, they may be stacked pickups or mounted vertically adjacent to each other on a common carrier. Switch 46 shows the ability of selecting full hum canceling, less than full hum canceling or single coil. Switch 46 may also be a two position switch which selects between full hum canceling and less than full hum canceling or a plural position switch for plural taps. Switch 44 shows the interconnection of various pickups 32, 34, 36. Switch 44 is but an example of the interconnection of a number of additional pickups. Other selections may be made at switch 44. All of the switches may be digital switches.

Although the present disclosure has been described and illustrated in detail, it is to be clearly understood that this is done by way of illustration and example only and is not to be taken by way of limitation. The scope of the present disclosure is to be limited only by the terms of the appended claims.

1. A stringed musical instrument having a pickup system comprising:
at least one dual coil pickup, each coil having first and second end terminals and at least one tap to a portion of the coil between the first and second end terminals; and
a first switch for selectively connecting first and second output terminals of a dual pickup circuit to (a) the first end terminals of both coils, (b) the first and second end terminals of one of the coils, and (c) the at least one tap of both coils.

2. The instrument according to claim 1, including a second dual coil pickup, each coil having first and second end terminals and at least one tap to a portion of the coil between the first and second end terminals, and
the first switch selectively connects the first and second output terminals of a dual pickup circuit to (a) the first end terminals of both coils of the second pickup, (b) the first and second end terminals of one of the coils of the second pickup, and (c) the at least one tap of both coils of the second pickup.

3. The instrument according to claim 2, wherein the first switch selectively connects the first and second output terminals of a pickup circuit to the first and second pickups simultaneously.

4. The musical instrument according to claim 2, including a second switch for selectively connecting the pickups individually via the first switch to the first output terminal of the pickup circuitry.

5. The musical instrument according to claim 4, wherein the second output terminal is connected to ground.

6. The musical instrument according to claim 2, wherein the dual coil pickups are wired as hum canceling pickups.

7. The instrument according to claim 1, including a second dual coil pickup, each coil having first and second end terminals and at least one tap to a portion of the coil between the first and second end terminals, and
a second switch selectively connects the first and second output terminals of the pickup circuit to (a) the first end terminals of both coils of the second pickup, (b) the first and second end terminals of one of the coils of the second pickup, and (c) the at least one tap of both coils of the second pickup.

8. The instrument according to claim 1, wherein the coils each include plural taps to portions of the coil between the first and second end terminals, and the first switch selectively connects the first and second output terminals of the pickup circuit to corresponding taps of both coils of the pickup.

9. The instrument according to claim 1, wherein the tap is to a portion of between 55 and 80 percent of the winding between the first and second terminals.

10. The pickup according to claim 1, wherein the second terminals of the first and second coils are connected to each other.

11. The musical instrument according to claim 1, including additional pickups and a second switch selectively connecting the coils selected by the first switch to the first output terminal.

12. The musical instrument according to claim 11, wherein the second output terminal is connected to ground.

13. The musical instrument according to claim 11, wherein the additional pickups include a dual coil pickup and a single coil pickup between the two dual coil pickups.

14. The musical instrument according to claim 11, wherein the first switch is a three-position blade switch and the second switch is a five-position blade switch.

15. The musical instrument according to claim 11, wherein the first switch is a three-position, six pole switch and the second switch is a five-position, two pole switch.

16. A stringed musical instrument having a pickup system comprising:
two dual coil pickups, each coil having first and second end terminals and at least one tap to a portion of the coil between the first and second end terminals; and
a first switch for selectively connecting first and second output terminals of a pickup circuit to (a) the first end terminals of both coils of both pickups and (b) the at least one tap of both coils of both pickups.

17. The musical instrument according to claim 16, wherein the first switch also selectively connects the first and second output terminals of a pickup circuit to the first and second end terminals of one of the coils of both pickups.

18. The musical instrument according to claim 16, including a second switch selectively connecting the coils selected by the first switch to the first output terminal.

19. A dual coil pickup for a stringed instrument, the pickup comprising:
first and second coils having first and second end terminals;
each coil having at least one tap to a portion of the coil between the first and second end terminal; and
the second end terminals connecting the two coils in a hum canceling arrangement between the first terminals and between the at least one taps.

20. The pickup according to claim 19, wherein the first and second coils are mounted vertically adjacent to each other on a common carrier.

21. The pickup according to claim 19, wherein the first and second coils are mounted horizontally adjacent to each other on a common carrier.

22. The instrument according to claim 19, wherein the coils each include plural taps to portions of the coil between the first and second end terminals, and plural hum canceling connection between corresponding taps of both coils of the pickup.

23. The instrument according to claim 19, wherein the tap is to a portion of between 55 and 80 percent of the winding between the first and second terminals.
